(19) United States
(12) Patent Application Publication
(10) Pub. No.: US 2025/0377609 A1
(43) Pub. Date: Dec. 11, 2025

(54) LIGHT EMITTING DEVICE, LIGHT EMITTING MODULE AND IMAGE FORMING APPARATUS

(71) Applicant: CANON KABUSHIKI KAISHA, Tokyo (JP)

(72) Inventors: SHOJI KONO, Tokyo (JP); MIZUKI NAGASAKI, Kanagawa (JP)

(21) Appl. No.: 19/228,340

(22) Filed: Jun. 4, 2025

(30) Foreign Application Priority Data
Jun. 10, 2024 (JP) 2024-093861

(51) Int. Cl. G03G 15/041; B41J 2/447; B41J 2/47; B41J 29/00; G03G 15/00; G03G 15/04; G06K 15/12

(52) U.S. Cl. CPC G03G 15/0415; B41J 2/447; B41J 2/47; B41J 29/00; G03G 15/04036; G03G 15/80; G06K 15/12

(57) ABSTRACT

A light emitting device is provided that includes a substrate with a light emitting region in which light emitting elements are arranged, the light emitting region extending in a longitudinal direction; a processor configured to process a data signal for controlling the light emitting elements in accordance with a clock signal; and terminals aligned in the longitudinal direction. The terminals include a first terminal, a second terminal, and a third terminal. The second terminal and the third terminal are arranged adjacent to each other. The processor and the terminals are arranged in the longitudinal direction. The second terminal is supplied with one of the clock signal and the data signal. The third terminal is supplied with one of another clock signal and data signal.

### BACKGROUND

### Field

The present disclosure relates to a light emitting device, a light emitting module, and an image forming apparatus.

### Related Art

Proposed is a print head for an image forming apparatus, which uses an organic light emitting diode (OLED) as a light emitting source. Japanese Patent Laid-Open No. 2023-174522 discusses a light emitting device in which an OLED and a driving transistor for driving the OLED are formed on one substrate. Since the OLED and the driving transistor can be formed on the same substrate, miniaturization and cost reduction are possible. Japanese Patent Laid-Open No. 2023-174522 also discusses that a plurality of signals such as a clock signal and a data signal are supplied to the light emitting device, and signal processing is performed therein.

In a light emitting device discussed in Japanese Patent Laid-Open No. 2023-174522, for miniaturization, it is considered to arrange a plurality of terminals to be supplied with a plurality of signals and a processing circuit configured to perform signal processing such that they are aligned in one direction. In this case, since the distance between each terminal and the processing circuit is longitudinally extended, a layout considering a signal delay between the terminal and the processing circuit is required.

### SUMMARY

Certain embodiments of the present disclosure provide a technique advantageous for the stable operation of a light emitting device.

An embodiment of the present disclosure provides a light emitting device that includes a substrate with a light emitting region in which a plurality of light emitting elements are arranged, the light emitting region extending in a longitudinal direction; a processing circuit configured to process a data signal for controlling a light emission luminance of each light emitting element of the plurality of the light emitting elements in accordance with a clock signal; and a plurality of terminals aligned in the longitudinal direction. The plurality of terminals include a first terminal, a second terminal, and a third terminal, with the second terminal and the third terminal arranged adjacent to each other. The processing circuit and the plurality of terminals are arranged in the longitudinal direction. The second terminal is supplied with one of the clock signal and the data signal, and the third terminal is supplied with one of another clock signal and data signal.

Further features of the various embodiments will become apparent from the following description of embodiments with reference to the attached drawings. The following description of embodiments are described by way of example.

### BRIEF DESCRIPTION OF THE DRAWINGS

FIG. 1 is a block diagram showing an example of the arrangement of a light emitting device according to an embodiment of the present disclosure;

FIG. 2 is a timing chart showing an example of signals input to the light emitting device according to the present disclosure;

FIG. 3 is a layout diagram showing an example of the arrangement of the light emitting device according to the present disclosure;

FIG. 4 is a layout diagram showing an example of the arrangement of the light emitting device according to the present disclosure;

FIG. 5 is a timing chart showing an example of signals input to the light emitting device according to the present disclosure;

FIG. 6 is a block diagram showing an example of the arrangement of the light emitting device according to the present disclosure;

FIG. 7 is a layout diagram showing an example of the arrangement of the light emitting device according to the present disclosure;

FIGS. 8A to 8C are views showing an example of the layout of the light emitting device on a wafer according to the present disclosure;

FIGS. 9A to 9E are views showing an example of steps for wire bonding of the light emitting device according to the present disclosure;

FIG. 10 is a layout diagram showing an example of the arrangement of a light emitting device according to the present disclosure;

FIGS. 11A to 11C are layout diagrams showing an example of an exposure head using the light emitting device according to the present disclosure;

FIGS. 12A and 12B are sectional views showing an example of the arrangement of a pixel of the light emitting device according to the present disclosure;

FIGS. 13A to 13C are views showing an example of an image forming apparatus using the light emitting device according to the present disclosure;

FIG. 14 is a view showing an example of a display apparatus using the light emitting device according to the present disclosure;

FIG. 15 is a view showing an example of a photoelectric conversion apparatus using the light emitting device according to the present disclosure;

FIG. 16 is a view showing an example of electronic equipment using the light emitting device according to the present disclosure;

FIGS. 17A and 17B are views each showing an example of a display apparatus using the light emitting device according to the present disclosure;

FIG. 18 is a view showing an example of an illumination apparatus using the light emitting device according to the present disclosure;

FIG. 19 is a view showing an example of a moving body using the light emitting device according to the present disclosure; and

FIGS. 20A and 20B are views each showing an example of a wearable device using the light emitting device according to the present disclosure.

### DETAILED DESCRIPTION

Exemplary embodiments of the present disclosure will be described hereinafter in detail, with reference to the accompanying drawings. It is to be understood that the following embodiments are not intended to limit the claims of the present disclosure, and that not all of the combinations of the aspects that are described in the embodiments are necessarily required with respect to the means to solve the issues according to the present disclosure. In the accompanying drawings, the same or similar configurations are assigned the same reference numerals, and redundant descriptions are omitted for conciseness.

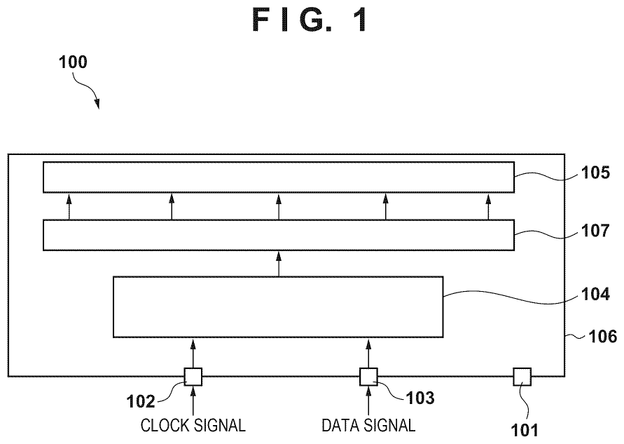

With reference to FIGS. 1 to 11C, a light emitting device according to an embodiment of the present disclosure will be described. In the following description, an example in which an OLED is used as a light emitting element arranged in the light emitting device will be described. However, the present disclosure is not limited to the light emitting device using the OLED, and is also applicable to light emitting devices in general.

FIG. 1 is a block diagram showing an example of the arrangement of a light emitting device 100 according to an embodiment. The light emitting device 100 includes a substrate 106 on which a light emitting region 105 where a plurality of light emitting elements are arranged, a scanning circuit 107, a processing circuit 104, and a plurality of terminals 101 to 103 which are supplied with signals and power, are arranged. In FIG. 1, as an example of signals supplied to the plurality of terminals 101 to 103, a clock signal is supplied to the terminal 102, and a data signal for controlling the light emission luminance and light emission timing of each of the plurality of light emitting elements arranged in the light emitting region 105 is supplied to the terminal 103. The terminal 101 may be supplied with another control signal, or the terminal 101 may function as a terminal for power supply. The processing circuit 104 obtains the data signal in synchronization with the clock signal. The processing circuit 104 processes the data signal in synchronization with the clock signal, and outputs a signal to the scanning circuit 107. The scanning circuit 107 scans the plurality of light emitting elements in accordance with the signal supplied from the processing circuit 104. With this, the plurality of light emitting elements arranged in the light emitting region 105 are sequentially scanned, and light emission or non-light emission of each light emitting element is controlled. In the light emitting region 105, the light emitting elements are arranged one-dimensionally or two-dimensionally.

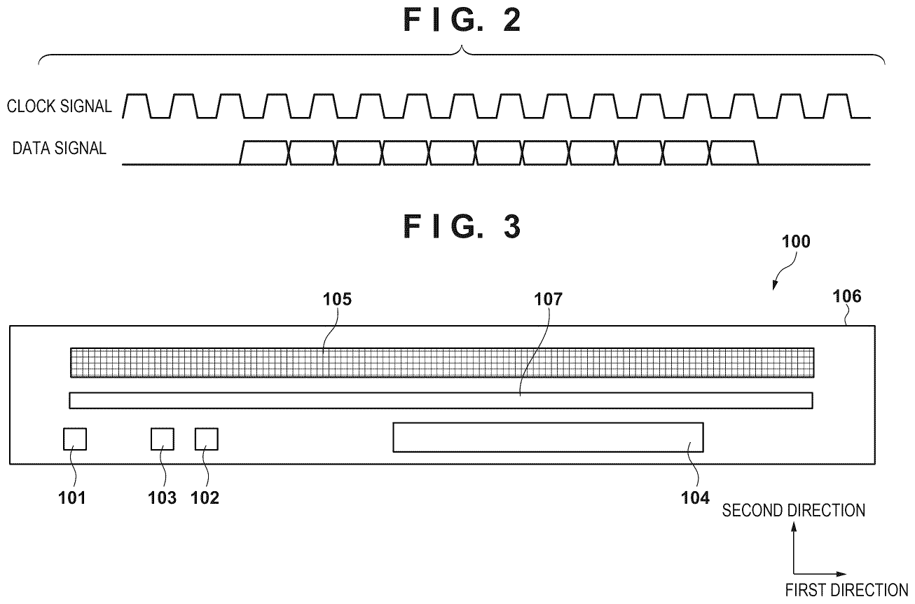

FIG. 2 is a view showing the timing relationship between the clock signal and the data signal which are externally input to the light emitting device 100. The clock signal and data signal input to the light emitting device 100 are obtained and processed by the processing circuit 104. In the example shown in FIG. 2, the processing circuit 104 obtains the data signal at the rising edge of the clock signal. That is, after nth data element is input at the nth rising edge of the clock signal, (n+1)th data element is input before the next (n+1)th rising edge of the clock signal. Accordingly, in one cycle of the clock signal, the data of the data signal which corresponds to each light emitting element transitions. If the data of the data signal transitions at the same time as the rising edge of the clock signal, the data to be obtained may change due to a slight deviation between the rising edge of the clock signal and the transition of the data signal. To avoid this, the data transitions at the falling edge of the clock signal, as shown in FIG. 2. Therefore, the pulse width of the clock signal is shorter than the transition cycle of the data of the data signal which corresponds to each light emitting element. The transition cycle of the data of the data signal is equal to one cycle of the clock signal. This can be two or more times the minimum pulse width of the clock signal.

The data obtained by the processing circuit 104 is processed in the processing circuit 104, and output from the processing circuit 104 to the scanning circuit 107 as a signal that decides the current amount required for light emission of the light emitting element or whether to execute light emission or non-light emission. The scanning circuit 107 sequentially scans the light emitting elements arranged in the light emitting region 105, and the light emitting element emits light with a light emission amount corresponding to the current amount.

FIG. 3 shows an example of the layout of the light emitting device 100 according to an embodiment. The light emitting device 100 used in a print head for an image forming apparatus, which uses an OLED as a light emitting source, can be arranged on the rectangular substrate 106 having long and short sides. In the arrangement shown in FIG. 3, the long side of the substrate 106 is referred to as the first direction, and the short side thereof is referred to as the second direction. As shown in FIG. 3, the substrate 106 may have a rectangular shape having four sides in a planar view. Alternatively, for example, the substrate 106 may have a polygonal shape such as an octagonal shape with chamfered corners in a planar view. The chamfered corners of the substrate 106 may be curved rather than straight. That is, the substrate 106 may have a substantially rectangular shape having long and short sides macroscopically. The planar view is an orthogonal projection to the surface of the substrate 106 where the light emitting region 105, the processing circuit 104, the scanning circuit 107, and the plurality of terminals 101 to 103 are arranged.

The light emitting region 105 is arranged on the substrate 106 such that the first direction is a longitudinal direction along the long side of the substrate 106. The plurality of terminals 101 to 103 are arranged to align in the first direction. The processing circuit 104 is arranged in the first direction with respect to the plurality of terminals 101 to 103. The light emitting region 105 is arranged in the second direction, which intersects the first direction, with respect to the processing circuit 104 and the plurality of terminals 101 to 103. The scanning circuit 107 is arranged between the processing circuit 104 and the light emitting region 105. Also, the scanning circuit 107 is arranged between the plurality of terminals 101 to 103 and the light emitting region 105.

In the arrangement shown in FIG. 3, the plurality of terminals 101 to 103 and the processing circuit 104 are arranged to align in the first direction. It is possible to arrange the plurality of terminals 101 to 103 so as to be adjacent to the processing circuit 104 in the second direction. In that case, the length of the substrate 106 in the short side direction (second direction) is increased. Accordingly, the layout area of the light emitting device 100 increases. As a result, when manufacturing the light emitting devices 100, the number of the light emitting devices 100 that can be arranged on one silicon wafer decreases. In order to increase the number of the light emitting devices 100 that can be obtained from one silicon wafer, the length of the short side of the substrate 106 can be shortened by arranging the processing circuit 104 and the plurality of terminals 101 to 103 so as to align in the first direction. Therefore, the layout as shown in FIG. 3 is often employed. In that case, the distance between the processing circuit 104 and each terminal, to which the clock signal or data signal is input, becomes long.

When a control signal such as the clock signal is transmitted in the light emitting device 100, a delay in signal transmission occurs due to the resistance of a signal line or parasitic capacitance with another wiring pattern or the like. As described above, in a configuration in which the data signal is obtained at the fall timing of the clock signal, a phase relationship between the clock signal and the data signal is to be considered. The operation timings are designed such that a temporal margin is ensured between the transition timing of the data signal and the rise timing of the clock signal. However, a delay in signal transmission may cause a deviation in the phase relationship between the clock signal and the data signal input to the light emitting device 100. For example, the time between the transition timing of the data signal and the rising edge of the clock signal can be reduced. In this case, the data may not be obtained correctly. In addition, the phase relationship can be influenced by manufacturing variations among the devices used in the circuit in the light emitting device, and temperature of use.

In order to reduce such problems, the above-described clock signal and data signal are supplied to adjacent terminals among the plurality of terminals 101 to 103. This reduces the difference between the wiring length from the terminal supplied with the clock signal to the processing circuit 104 and the wiring length from the terminal supplied with the data signal to the processing circuit 104. Accordingly, the difference in the amount of delay in signal transmission caused by the wiring resistance or the parasitic capacitance is reduced. This makes it easier to design the layout such that the delay of the clock signal and the data signal become equal even if a transmission delay occurs in the light emitting device 100. As a result, a data obtainment failure caused by the signal delay is suppressed, and the operation of the light emitting device 100 becomes stable.

For example, with terminals 102 and 103 adjacent to each other, one of the clock signal and the data signal is supplied to the terminal 102, and the other of the clock signal and the data signal is supplied to the terminal 103. In this case, the terminal 101 may be supplied with a signal that transitions at a cycle longer than the transition cycle of the data of the data signal which corresponds to each light emitting element. For example, the terminal 101 can be supplied with a signal whose signal value transitions slower than the data signal, such as a signal for causing the processing circuit 104 to start or end the obtainment of the data signal or the clock signal. Alternatively, for example, the terminal 101 may be a terminal for power supply. For example, the terminal 101 may be supplied with a power supply potential or a ground potential.

For example, the clock signal may be supplied to the terminal 102, the data signal may be supplied to the terminal 103, and power or a signal whose transition is slower than that of the data signal may be supplied to the terminal 101. Alternatively, for example, the data signal may be supplied to the terminal 102, the clock signal may be supplied to the terminal 103, and power or a signal whose transition is slower than that of the data signal may be supplied to the terminal 101. In the arrangement shown in FIG. 3, the terminals 101 and 103 are also adjacent to each other. Therefore, for example, power or a signal whose transition is slower than that of the data signal may be supplied to the terminal 102, the data signal may be supplied to the terminal 103, and the clock signal may be supplied to the terminal 101. As a further example, power or a signal whose transition is slower than that of the data signal may be supplied to the terminal 102, the clock signal may be supplied to the terminal 103, and the data signal may be supplied to the terminal 101.

As shown in FIG. 2, the pulse width of the clock signal is shorter than the data transition cycle of the data signal. Hence, the signal quality of the clock signal is easily influenced by the distance of the wiring pattern which it passes through, device variations, a temperature change, and the like. Therefore, the clock signal may be supplied to the terminal 102 closest to the processing circuit 104 among the plurality of terminals 101 to 103. This makes it possible to reduce data obtainment errors of the data signal due to timing deviations. That is, as shown in FIG. 3, the terminals 102 and 103 are arranged between the processing circuit 104 and the terminal 101, and the terminal 102 is arranged between the processing circuit 104 and the terminal 103. In this case, the clock signal may be supplied to the terminal 102, the data signal may be supplied to the terminal 103, and power or a signal whose transition is slower than that of the data signal may be supplied to the terminal 101. That is, among the plurality of terminals 101 to 103, the terminal closer to the processing circuit 104 may be supplied with a signal having a shorter cycle. This implements the stable operation of the light emitting device 100.

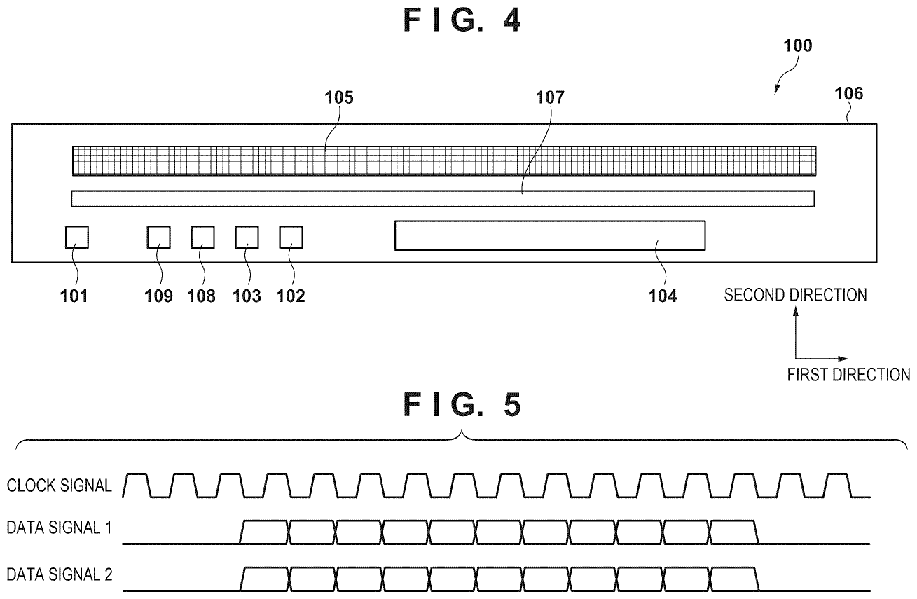

FIG. 4 shows a modification of the light emitting device 100 shown in FIG. 3. In the arrangement shown in FIG. 4, terminals 108 and 109 are arranged in addition to the above-described terminal 101 to 103. The terminals 108 and 109 are arranged between the terminal 101 and the terminal 103. Similar to the arrangement shown in FIG. 3, the terminals 101 to 103, 108, and 109 are arranged to align in the first direction.

For example, the clock signal is supplied to the terminal 102, a data signal 1 is supplied to the terminal 103, and a data signal 2 is supplied to the terminal 108. Similar to the above description, the pulse width of the clock signal is shorter than the data transition cycles of the data signals 1 and 2. The data signal 2 supplied to the terminal 108 has a data transition cycle equal to or longer than the data transition cycle of the data signal 1 supplied to the terminal 103, that is, a signal that transitions at a cycle equal to or longer than the data transition cycle of the data signal 1. In this embodiment, the transition cycles of the data signals 1 and 2 are equal. Each of the terminals 101 and 109 may be, for example, a terminal for power supply. Alternatively, each of the terminals 101 and 109 may be supplied with a signal whose transition is slower than that of the data signals 1 and 2. In the example shown in FIG. 4, two terminals supplied with the data signals are provided. However, the number of the terminals is not limited to two, and three or more terminals may be arranged. For example, a data signal similar to the data signals 1 and 2 may be supplied to the terminal 109.

FIG. 5 shows an example of the operation of the light emitting device 100 shown in FIG. 4. FIG. 5 shows a case in which, similar to the operation shown in FIG. 2, the data signals 1 and 2 are obtained at the falling edge of the clock signal, and two data are obtained simultaneously. Similar to the above description, since the data signal 1 and the data signal 2 are respectively obtained using the same clock signal, the present disclosure reduces the difference in delay among the clock signal and the data signals 1 and 2.

In the arrangement shown in FIG. 4, timing deviations between the clock signal and the data signals caused by a signal delay or manufacturing variations among the circuit devices in the light emitting device 100, the use temperature, or the like are considered. That is, the terminal 102 to which the clock signal is input, whose pulse width is shorter than the data transition cycle of each of the data signals 1 and 2, is arranged at a position close to the processing circuit 104. Then, the terminals 103 and 108 to which the data signals 1 and 2 are input, respectively, are arranged at positions farther from the processing circuit 104 than the terminal 102. On the other hand, the terminal 102 supplied with the clock signal and the terminal 103 supplied with the data signal 1 are arranged adjacent to each other, and the terminal 103 supplied with the data signal 1 and the terminal 108 supplied with the data signal 2 are arranged adjacent to each other. With this arrangement, the difference in an amount of delay between the clock signal and the data signal is suppressed, and the operation of the light emitting device 100 can become stable. This implements the stable operation of the light emitting device 100. In the arrangement shown in FIG. 4, as the distance from the processing circuit 104 increases, the cycles of the signals supplied to the plurality of terminals 101 to 103, 108, and 109, respectively, may become longer continuously or stepwise. If mixing of noise or the like is not considered, the terminal supplied with power can be regarded as a terminal supplied with a signal having the longest cycle.

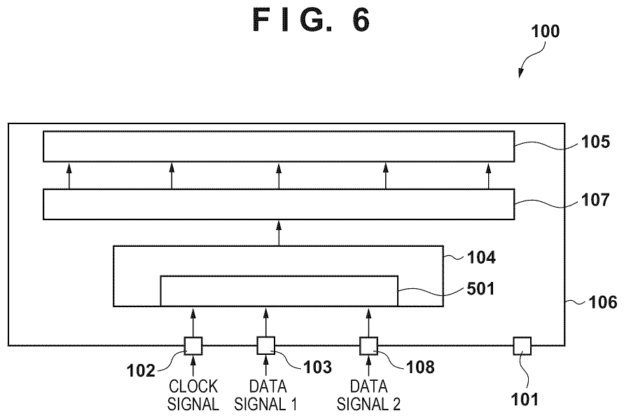

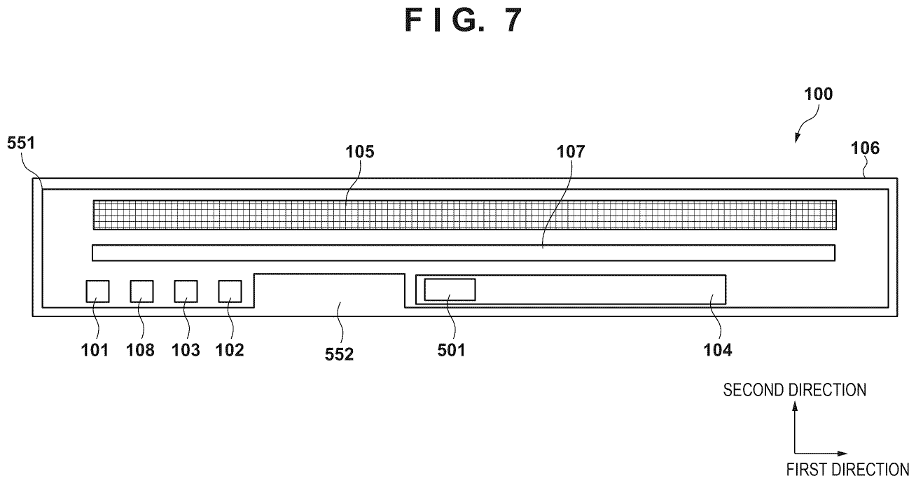

FIG. 6 is a block diagram showing an example of the arrangement of the light emitting device 100. FIG. 7 is a view showing an example of the layout of the light emitting device 100. Differences from the arrangement of the light emitting device 100 are described below, and a description of the arrangement that may be similar to the above-described arrangement is omitted for conciseness.

As shown in FIGS. 6 and 7, an obtaining circuit 501, to which the clock signal and the data signal are input, is arranged in the processing circuit 104. The obtaining circuit 501 can also be arranged in the above-described processing circuit 104. In the processing circuit 104, the obtaining circuit 501 obtains the data of the data signal at the rise timing of the clock signal. Considering a signal delay and the like, it is considered that a shorter distance between the terminal to which the clock signal or the data signal is input and the obtaining circuit 501 in the processing circuit 104 to which the clock signal or the data signal is input is more suitable. Accordingly, as shown in FIG. 7, in a planar view with respect to the substrate 106, the obtaining circuit 501 may be arranged at a position closer to the plurality of terminals 101 to 103 and 108 than the center of the processing circuit 104. With this arrangement, it is possible to reduce the length of the wiring pattern between the obtaining circuit 501 and the terminal supplied with the clock signal or the data signal. The center of the processing circuit 104 may be, for example, the geometric centroid position of the processing circuit 104 in the planar view with respect to the substrate 106. The geometric shape of the processing circuit 104 can be defined by, for example, the outer edges of transistors arranged on the outermost periphery among the transistors constituting the processing circuit 104 and a virtual line connecting the outer edges. The shape of the obtaining circuit 501 can be defined similarly to the shape of the processing circuit 104.

Also in the arrangement shown in FIGS. 6 and 7, two data signals, data signal 1 and data signal 2, are input. The number of the data signals to be supplied is not limited to two, and may be one or three or more. Only the number of terminals, to which data signals are input, is larger than the number of the data signals to be supplied. In the arrangement shown in FIG. 7, for example, the clock signal can be supplied to the terminal 102, the data signals 1 and 2 can be supplied to the terminals 103 and 108, respectively, and power or a signal whose transition is slower than those of the data signals can be supplied to the terminal 101.

FIG. 7 also shows the arrangement of a moisture-proof ring 551. The moisture-proof ring 551 can be a guard ring formed by a conductive pattern arranged in a wiring layer on the semiconductor substrate to protect components such as the processing circuit 104, the light emitting region 105, and the scanning circuit 107 from moisture in the atmosphere and the like. In the orthogonal projection to the substrate 106, as shown in FIG. 7, the moisture-proof ring 551 can be arranged to surround the light emitting region 105, the scanning circuit 107, the processing circuit 104, and the plurality of terminals 101 to 103 and 108 along the outer edge of the substrate 106. In the planar view with respect to the substrate 106, the moisture-proof ring 551 may include a concave portion 552 that recesses inward of the substrate 106 between the plurality of terminals 101 to 103 and 108 and the processing circuit 104. As described herein, the concave portion 552 of the moisture-proof ring 551 is a portion provided for a step of vapor-depositing an OLED to the light emitting device 100.

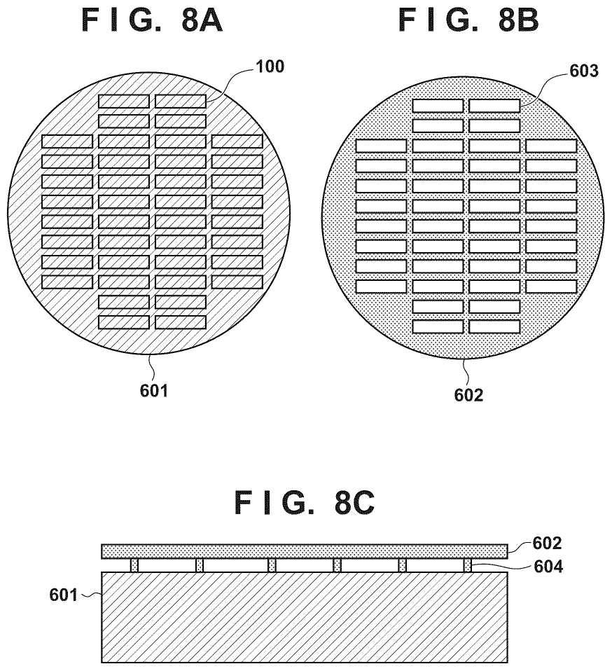

FIG. 8A shows an example in which the light emitting device 100 is formed on a silicon wafer 601. The light emitting device 100 may be formed on a semiconductor substrate made of silicon or the like as shown in FIG. 8A, or may be formed on a semiconductor layer formed on a substrate made of a plastic, glass, ceramic, a metal, or the like. The semiconductor substrate and the semiconductor layer are not limited to silicon, and other semiconductor materials may be used. For example, the material for the semiconductor substrate or the semiconductor layer may be germanium or a compound semiconductor. The compound semiconductor may be gallium arsenide, indium phosphide, indium arsenide, indium gallium arsenide phosphide, or one of these semiconductor materials further containing aluminum. In this embodiment, the light emitting devices 100 can be formed to form a plurality of rows and a plurality of columns on one silicon wafer 601. In a case of the rectangular light emitting device 100, depending on the size in the short side direction, the number of the light emitting devices 100 that can be obtained from one silicon wafer 601 significantly changes. Therefore, reducing the size in the short side direction as much as possible is effective in reducing the cost of the light emitting device 100. In addition, by using the silicon wafer 601 as the substrate (which becomes the substrate 106 when the light emitting device 100 is completed), it is possible to finely form each component such as the driving circuit. As a result, it is possible to increase the density of the light emitting elements, and form an image with a higher resolution.

FIG. 8B shows an example of a vapor deposition mask 602 used to form an OLED on the light emitting device 100 by vapor deposition. A plurality of opening portions 603 are arranged in the vapor deposition mask 602, and the arrangement interval of the opening portions 603 is equal to that of the light emitting devices 100 (for example, the light emitting regions 105). The light emitting devices 100 on the silicon wafer 601 are aligned with the opening portions 603 in the vapor deposition mask 602. Then, the silicon wafer 601 and the vapor deposition mask 602 are brought into tight contact with each other, and electrodes, an organic layer, and the like are vapor-deposited on each light emitting device using a vacuum vapor deposition method to form an OLED.

FIG. 8C shows an example of the sectional structure when the silicon wafer 601 and the vapor deposition mask 602 are in tight contact with each other. Ribs 604 are arranged on the vapor deposition mask 602. When the silicon wafer 601 and the vapor deposition mask 602 are in tight contact with each other, these ribs 604 maintain a constant distance between the silicon wafer 601 and the vapor deposition mask 602. With this, the area where the vapor deposition mask 602 touches the light emitting device 100 is minimized, thereby suppressing transfer of a foreign substance to the light emitting device 100 and occurrence of a scratch. Thus, occurrence of a sealing failure or the like is suppressed. The portion where the rib 604 is arranged corresponds to the concave portion 552 of the moisture-proof ring 551 shown in FIG. 7.

It is possible to provide a portion, where the rib 604 is arranged, in the second direction with respect to the terminals 101 to 103 and 108 and the processing circuit 104, without providing the concave portion 552 of the moisture-proof ring 551 between the plurality of terminals 101 to 103 and 108 and the processing circuit 104. However, in that case, the region dedicated for the rib 604 is provided in the second direction (short side direction) between the light emitting devices 100 on the silicon wafer 601, so that the substantial chip size increases by the area dedicated to the rib. In this embodiment, the concave portion 552 of the moisture-proof ring 551 as the region where the rib 604 abuts is arranged between the terminal 101 to 103 and 108 and the processing circuit 104. With this arrangement, it is possible to reduce the distance between the light emitting devices 100 in the direction (second direction) of the short side of the substrate 106 of the light emitting device 100 on the silicon wafer 601. Hence, it is possible to increase the number of the light emitting devices 100 that can be arranged in the short side direction in one silicon wafer 601, thereby increasing the number of the light emitting devices 100 that can be obtained from one silicon wafer 601.

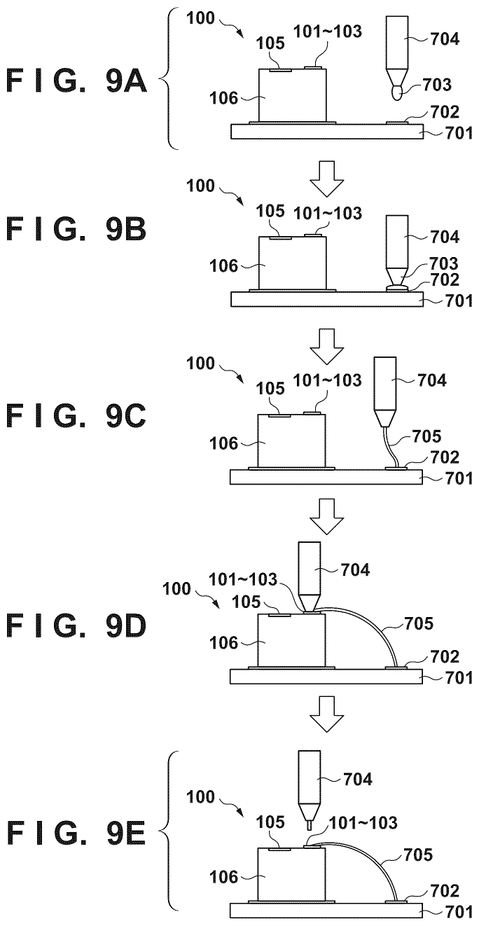

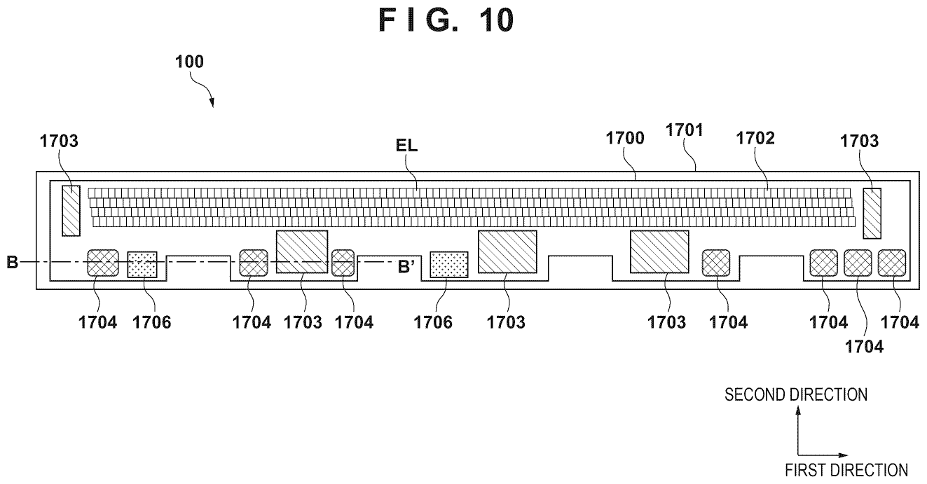

FIGS. 9A to 9E show steps for mounting the light emitting device 100 on a control board 701. Each of the terminals 101 to 103 (in FIGS. 9A to 9E, the terminals 101 to 103 are shown, but other terminals such as the above-described terminals 108 and 109 may be arranged) provided in the light emitting device 100 is electrically bonded to a wiring pattern 702 of the control board 701 by wire bonding. Thus, the light emitting device 100 is mounted as an electronic component. FIGS. 9A to 9E show the light emitting device 100 when viewed from the side surface.

As shown in FIG. 9A, a capillary 704 on which a ball 703 is formed is moved to directly above the wiring pattern 702 using a wire bonding apparatus. Then, as shown in FIG. 9B, the capillary 704 is lowered using the wire bonding apparatus, the ball 703 melted by the capillary 704 is pressed against the wiring pattern 702, and a wire 705 and the wiring pattern 702 are connected by, for example, an ultrasonic thermo-compression bonding method. Thereafter, as shown in FIG. 9C, the wire 705 is drawn out from the tip of the capillary 704 using the wire bonding apparatus and moved toward one of the terminals 101 to 103 of the light emitting device 100. Then, as shown in FIGS. 9D and 9E, the capillary 704 is pressed against the one of the terminals 101 to 103 using the wire bonding apparatus to connect the wire 705 to the one of the terminals 101 to 103 by an ultrasonic thermo-compression bonding method, and at the same time, the wire 705 is cut. By using this wire bonding method, wire bonding is executed on the plurality of light emitting devices 100 arranged on the control board 701.

FIG. 10 is a schematic view showing one form of the light emitting device 100 according to an embodiment. The light emitting device 100 can be used as, for example, the light source of an image forming apparatus. The light emitting device 100 may have a rectangular shape having long sides parallel to the first direction and short sides parallel to a direction intersecting the first direction. For example, the first direction may be a direction along the rotational axis direction of the photosensitive member of the image forming apparatus.

A substrate 1701 has a polygonal shape. An example of the substrate 1701 having a rectangular shape will be described here. Herein, the long side direction of the rectangular substrate 1701 is called the first direction, and the short side direction orthogonal to the long side direction is called the second direction. The polygonal shape includes a shape having round corners. A moisture-proof ring 1700 is placed on the rectangular substrate 1701. The moisture-proof ring 1700 serves to suppress and prevent moisture from entering the light emitting device 100. The moisture-proof ring 1700 can be, for example, a guard ring formed from a wiring layer.

The moisture-proof ring 1700 is internally provided with a light emitting region 1702, contact regions 1703, pads 1704, and circuits 1706. The circuits 1706 are each for driving the light emitting device. Specific examples of the circuits include an input protection circuit, an input circuit to which each drive data is input, and a logic circuit for processing data, without limitation thereto. Light emitting elements EL are arrayed in the row and column directions in the light emitting region 1702. The contact regions 1703 are regions where wirings electrically connected to the common electrodes of the light emitting elements EL are arranged. The pads 1704 correspond to the above-described terminals 101 to 103, 108, and 109. The positional relationship between the processing circuit, among the circuits 1706, such as a logic circuit to which a clock signal and a data signal are input and which processes the data signal in accordance with the clock signal, and the respective pads 1704 is as described above.

The outer peripheral shape of the moisture-proof ring 1700 may have a plurality of concave portions. These portions can be used as, for example, abutment regions on which ribs as parts of a mask for vapor deposition in a film forming process are made to abut.

Each of the plurality of light emitting elements EL arrayed in a matrix pattern in the light emitting region 1702 is constituted by a light emitting layer and first and second electrodes sandwiching the light emitting layer. The first electrode can be an independent electrode provided for each light emitting element EL, and the second electrode can be a common electrode commonly provided for the respective light emitting elements EL.

If, for example, the light emitting elements EL are arranged on four rows in the light emitting region 1702, the position of the first light emitting element EL on the first row and the position of the first light emitting element EL on the second row may be shifted from each other by ¼ of the X-direction size of the light emitting element EL in the first direction, as exemplified in FIG. 10. In the case of n rows (where n is an integer of 2 or more), the position of the first light emitting element EL on the first row and the position of the first light emitting element EL on the second row may be shifted from each other by 1/n of the X-direction size of the light emitting element EL in the X direction. Such arrangement is advantageous in improving the resolution.

The contact regions 1703 are adjacent regions of the light emitting region 1702 of the substrate 1701 and arranged inside the moisture-proof ring 1700. At least one of the contact region 1703, the pad 1704, and the circuit 1706 may be placed between the light emitting region 1702 and one of the long side end portions of the substrate 1701 together with the concave portion of the moisture-proof ring 1700 and located in series with the long side direction (the first direction).

Providing the contact regions 1703, the pads 1704, and the circuits 1706 at positions in the same short side direction in this manner can reduce the length of the light emitting device 100 in the short side direction (second direction) and miniaturize the light emitting device 100.

The light emitting device 100 includes the plurality of contact regions 1703 between the common electrodes and the power supply wirings of the light emitting elements EL along the long side end of the light emitting device. If, for example, the common electrode is made of a transparent electrode material having a relatively high electric resistance, the voltage drop amount sometimes increases in the long side direction. The voltages applied to the respective OLEDs differ depending on the distances from the contact regions to which potentials are supplied. This causes differences in actual light emission luminance among the OLEDs to which voltages for light emission of the same luminance are applied, thus sometimes causing shading or the like. Having the plurality of contact regions 1703 in the long side direction can suppress voltage drops at the common electrodes in the long side direction, thereby suppressing the occurrence of shading or the like.

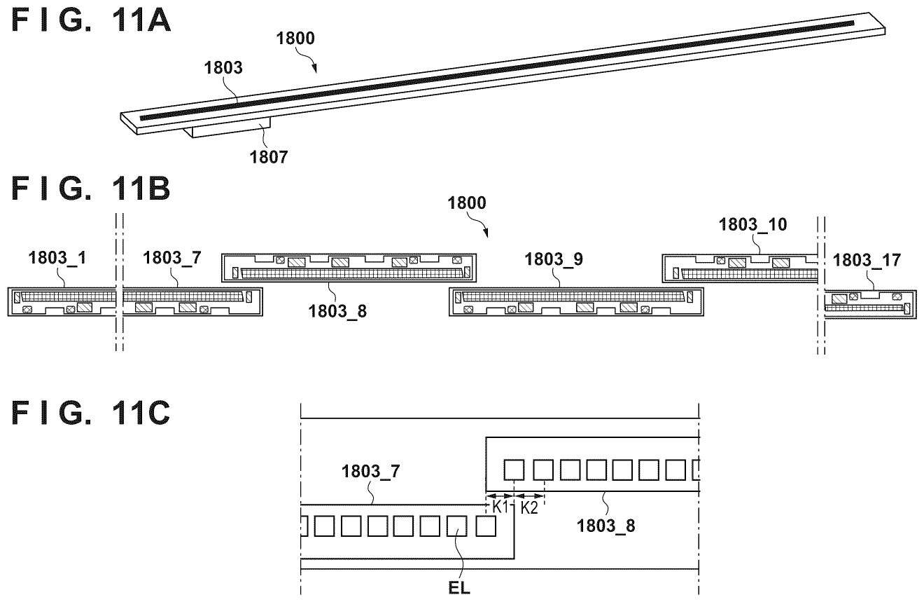

With reference to FIGS. 11A to 11C, an example is provided using the light emitting device 100 for a head substrate 1800 of an exposure head as a light emitting module of an image forming apparatus. FIG. 11A is a schematic perspective view of the head substrate 1800. FIG. 11B shows an array of the plurality of light emitting elements EL provided on the head substrate 1800. FIG. 11C is an enlarged view of part of FIG. 11B.

LED chips 1803 are mounted on the head substrate 1800. As the LED chip 1803, for example, the light emitting device 100 described above can be used.

As shown in FIG. 11A, the LED chips 1803 are provided on one surface of the head substrate 1800, and a long flexible flat cable (FFC) connector 1807 is provided on the other surface. One surface of the head substrate 1800 in this case is the surface (the upper surface or obverse surface) on which the LED chips 1803 are provided. The other surface of the substrate is the surface (the lower surface or reverse surface) opposite to the side where the LED chips 1803 are provided.

The FFC connector 1807 is attached to the other surface (the lower surface or reverse surface) of the head substrate 1800 such that the longitudinal direction of the FFC connector 1807 extends along the longitudinal direction of the head substrate 1800. The long FFC connector 1807 is provided to receive a control signal (drive signal) from a control circuit unit of the main body of the image forming apparatus. The control signal is transferred to each LED chip 1803. The LED chip 1803 is driven (for light emission or turn-off operation) in accordance with the control signal input to the head substrate 1800.

The LED chips 1803 mounted on the head substrate 1800 will be described. As shown in FIGS. 11B and 11C, the plurality of light emitting elements EL are arranged on one surface of the head substrate 1800. For example, a plurality (17) of LED chips 1803-1 to 1803-17 are arrayed. FIG. 11B exemplarily shows the LED chips 1803_1, 1803_7, 1803_8, 1803_9, 1803_10, and 1803_17. In each of the LED chips 1803_1 to 1803_17, the plurality of light emitting elements EL are arranged in the longitudinal direction, and for example, 516 light emitting elements EL are arrayed.

An inter-center distance k2 of the adjacent light emitting elements EL in the longitudinal direction of the LED chip 1803 corresponds to the resolution of the image forming apparatus. If, for example, the resolution of the image forming apparatus is 1,200 dpi, the light emitting elements EL are arrayed such that the inter-center distance k2 between the adjacent light emitting elements EL in the longitudinal direction of the LED chips 1803_1 to 1803_17 is 21.16 μm. Accordingly, the exposure range of the exposure head becomes about 314 mm.

The photosensitive layer of the photosensitive drum is formed to have a width of 314 mm or more. Since the length of a long side of an A4 size recording sheet and the length of a short side of an A3 size recording sheet are 297 mm, the exposure head has an exposure range that allows the formation of images on both an A4 size recording sheet and an A3 size recording sheet. FIG. 11C shows an example in which the plurality of light emitting elements EL are arrayed in the longitudinal direction. However, the light emitting elements EL may be arrayed in the transverse direction in addition to the longitudinal direction.

The LED chips 1803_1 to 1803_17 are arrayed in the axial direction of the photosensitive drum. More specifically, the LED chips 1803_1 to 1803_17 are alternately arranged in two lines along the axial direction of the photosensitive drum. That is, as shown in FIG. 11B, the odd-numbered LED chips 1803_1, 1803 3, . . . 1803_17, counted from the left, are mounted in one line in the longitudinal direction of the head substrate 1800. The even-numbered LED chips 1803_2, 1803_4, . . . 1803_16, counted from the left, are mounted in one line in the longitudinal direction of the head substrate 1800. The LED chips 1803 are arranged in this manner. As exemplified in FIG. 11C, this makes it possible to equalize an inter-center distance k1 between the light emitting elements EL with the inter-center distance k2 between the light emitting elements EL in the longitudinal direction of the LED chip 1803. The inter-center distance k1 between the light emitting elements EL indicates the inter-center distance between the light emitting element EL on one end of the LED chip 1803_7 and the light emitting element EL on the other end of the LED chip 1803_8. The inter-center distance k2 between the light emitting elements EL indicates the inter-center distance k2 between the adjacent light emitting elements EL in the LED chip 1803_8.

That is, it is possible to equalize the inter-center distance k1 between the adjacent light emitting elements EL arranged on one end of the LED chip 1803 and the other end of the other LED chip 1803 with the inter-center distance k2 between the adjacent light emitting elements EL on one LED chip 1803.

The light emitting element EL is an organic light emitting element and a current-driven light emitting element. For example, organic light emitting elements are arranged on a line on a thin-film transistor (TFT) substrate along the main scanning direction (the axial direction of the photosensitive drum) and are electrically connected in parallel to each other with a power supply wiring provided along the main scanning direction.

If light emitting devices are used for an exposure head, to perform linear exposure, the light emitting region 1702 is shaped such that the ratio between the length in the longitudinal direction (first direction) and the length in the transverse direction (second direction) becomes large as compared with a case where light emitting devices are used for a display apparatus or the like. The substrate of each LED chip is also shaped such that the ratio between the length in the longitudinal direction (first direction) and the length in the transverse direction (second direction) becomes large.

More specifically, for example, the length of a long side of the LED chip 1803 (or the light emitting region 1702) is five or more times or may be 10 or more times the length of a short side of the LED chip 1803 (or the light emitting region 1702). For example, the length of a long side of the LED chip 1803 (or the light emitting region 1702) can be 20 or more times the length of a short side of the LED chip 1803 (or the light emitting region 1702).

The length of a long side of the LED chip 1803 is determined by the length of the photosensitive drum in the axial direction, the number of LED chips arranged in the axial direction, and the manner of arranging the LED chips 1803. The length of a short side of the LED chip 1803 is determined by whether the light emitting elements EL are arranged in the light emitting region 1702 in a direction perpendicular to the axis of the photosensitive drum and the placements of the pads 1704 and the contact regions 1703.

In addition, the organic layer can be configured to have a light emitting layer that emits red light in consideration of the wavelength dependence of the photosensitivity of the photosensitive drum. The LED chip 1803 may have a color filter. Having a color filter makes it possible to absorb stray light from unintentional directions without reducing the regular amount of light entering the photosensitive drum, thereby improving the print quality.

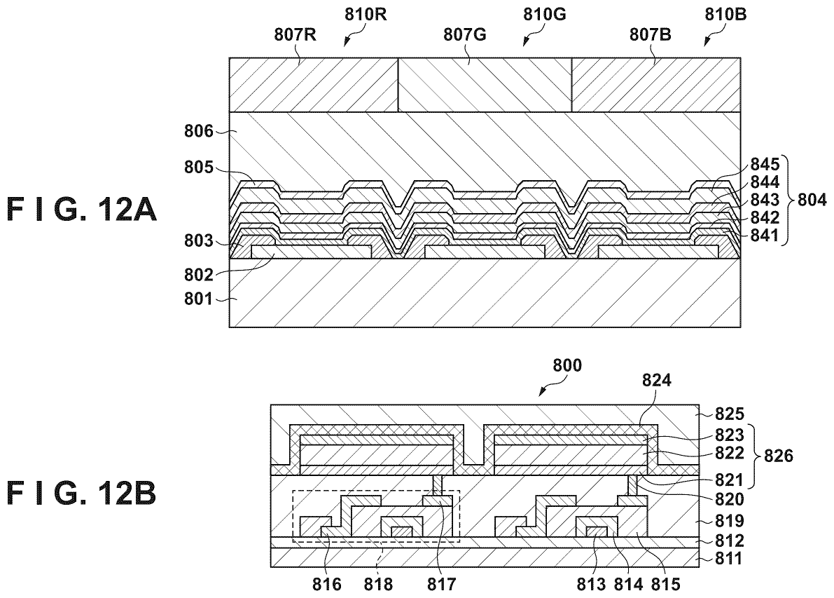

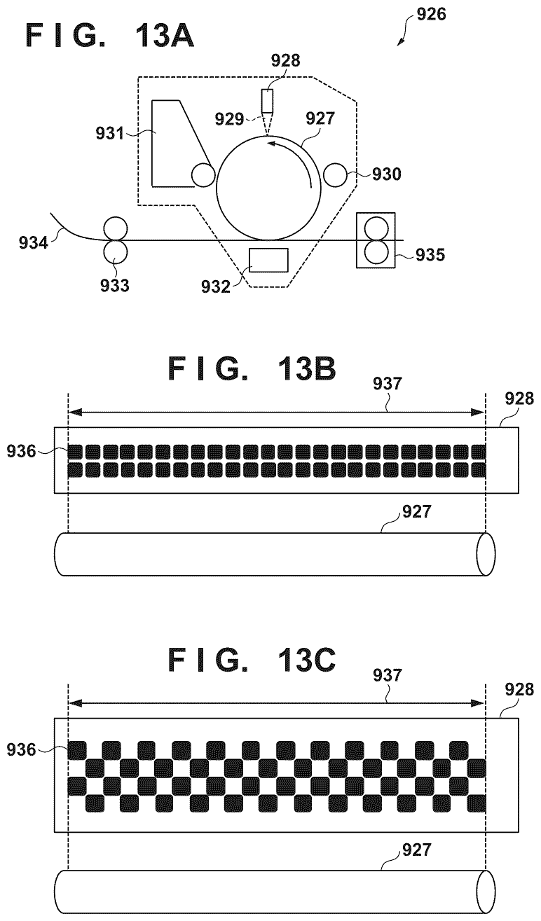

Application examples in which the light emitting device 100 is applied to an image forming apparatus, a display apparatus, a photoelectric conversion apparatus, electronic equipment, an illumination apparatus, a moving body, and a wearable device will be described with reference to FIGS. 12A to 20B. The description will be given assuming that, for example, a light emitting element such as an OLED using an organic light emitting material is arranged in the pixel arranged in the light emitting device 100. Details of each component arranged in the pixel of the light emitting device 100 described above will be described first, and the application examples will be described after that.

The organic light emitting element includes a first electrode, a second electrode, and an organic compound layer arranged between these electrodes. One of the first electrode and the second electrode is an anode, and the other is a cathode. In the organic light emitting element, the organic compound layer may be either a single layer or a stacked body formed by layers that include a light emitting layer. If the organic compound layer is a stacked body formed from layers, the organic compound layer may include a hole injection layer, a hole transport layer, an electron blocking layer, a hole/exciton blocking layer, an electron transport layer, an electron injection layer, and the like in addition to the light emitting layer. The light emitting layer may be a single layer or a stacked body formed from layers. If the light emitting layer includes layers, a charge generation layer may be arranged between the light emitting layers. The charge generation layer may be made of a compound having the lowest unoccupied molecular orbit (LUMO) lower than that of the hole transport layer, and the LUMO of the charge generation layer may be lower than the highest occupied molecular orbit (HOMO) of the hole transport layer. The molecular orbital energy of the organic compound layer may be the molecular orbital energy of the organic compound with the largest weight ratio in the organic compound layer.

In the organic light emitting element, if an organic compound is contained in the light emitting layer, the light emitting layer may be a layer made of only the organic compound or a layer made of the organic metal complex and another compound. Here, if the light emitting layer is a layer made of the organic metal complex and another compound, the organic compound may be used as a host or a guest of the light emitting layer. Alternatively, the organic compound may be used as an assist material that can be contained in the light emitting layer. Here, the host is a compound whose mass ratio is largest in the compounds forming the light emitting layer. The guest is a compound whose mass ratio is smaller than that of the host in the compounds forming the light emitting layer, and is a compound responsible for main light emission. The assist material is a compound whose mass ratio is smaller than that of the host in the compounds forming the light emitting layer, and which assists light emission of the guest. The assist material may also be referred to as a second host. The host material can be called a first compound, and the assist material as a second compound.

For the organic compound, a conventionally known low molecular and high molecular hole injection compound or hole transport compound, a compound serving as a host, a light emitting compound, an electron injection compound or electron transport compound, or the like can be used together as needed.

As a hole injection/transport material, a material can be used that has a high hole mobility such that hole injection from the anode is facilitated, and injected holes can be transported to the light emitting layer. Also, a material having a high glass transition point temperature can suitably be used to reduce degradation of film quality such as crystallization in the organic light emitting element.

The electron transport material can be selected from materials capable of transporting electrons injected from the cathode to the light emitting layer, and is selected in consideration of balance to the hole mobility of the hole transport material. The electron transport material can also be used for the hole blocking layer.

The electron injection material can be selected from materials capable of facilitating electron injection from the cathode, and is selected in consideration of balance to hole injection. The electron injection material can also be used together with the electron transport material.

### Configuration of Organic Light Emitting Element

The organic light emitting element is provided by forming an insulating layer, a first electrode, an organic compound layer, and a second electrode on a substrate. A protection layer, a color filter, a microlens, and the like may be provided on a cathode. If a color filter is provided, a planarizing layer may be provided between the protection layer and the color filter. The planarizing layer can be formed using acrylic resin or the like. The same applies to a case where a planarizing layer is provided between the color filter and the microlens.

### Substrate

Quartz, glass, a silicon wafer, a resin, a metal, or the like may be used as a substrate. A switching element such as a transistor, a wiring pattern, and the like may be provided on the substrate, and an insulating layer may be provided thereon. When using a silicon wafer as the substrate, the active layer, source region, and drain region of a transistor are formed in the substrate. This is suitable since dense arrangement of the transistors is possible. The insulating layer may be made of any material as long as a contact hole can be formed so that the wiring pattern can be formed between the first electrode and the substrate and insulation from the unconnected wiring pattern can be ensured. For example, a resin such as polyimide, silicon oxide, silicon nitride, or the like may be used for the insulating layer.

### Electrode

A pair of electrodes can be used, and the pair of electrodes form an anode and a cathode. If an electric field is applied in the direction in which the organic light emitting element emits light, the electrode having a high potential is the anode, and the other is the cathode. It can also be said that the electrode that supplies holes to the light emitting layer is the anode and the electrode that supplies electrons is the cathode.

As the constituent material of the anode, a material having a large work function may be selected. For example, a metal such as gold, platinum, silver, copper, nickel, palladium, cobalt, selenium, vanadium, or tungsten, a mixture containing some of them, an alloy obtained by combining some of them, or a metal oxide such as tin oxide, zinc oxide, indium oxide, indium tin oxide (ITO), or zinc indium oxide can be used. A conductive polymer such as polyaniline, polypyrrole, or polythiophene can also be used as the constituent material of the anode.

One of these electrode materials may be used singly, or two or more of them may be used in combination. The anode may be formed by a single layer or multiple layers.

If the electrode is used as a reflective electrode, for example, chromium, aluminum, silver, titanium, tungsten, molybdenum, an alloy thereof, a stacked layer thereof, or the like can be used. The above materials can function as a reflective film having no role as an electrode. If a transparent electrode is used as the electrode, an oxide transparent conductive layer made of ITO, indium zinc oxide, or the like can be used, but the present disclosure is not limited thereto. A photolithography technique can be used to form the electrode.

On the other hand, as the constituent material of the cathode, a material having a small work function may be selected. Examples of the material include an alkali metal such as lithium, an alkaline earth metal such as calcium, a metal such as aluminum, titanium, manganese, silver, lead, or chromium, and a mixture containing some of them. Alternatively, an alloy obtained by combining these metals can also be used. For example, a magnesium-silver alloy, an aluminum-lithium alloy, an aluminum-magnesium alloy, a silver-copper alloy, a zinc-silver alloy, or the like can be used. A metal oxide such as ITO can also be used. One of these electrode materials may be used singly, or two or more of them may be used in combination. The cathode may have a single-layer structure or a multilayer structure. Silver may be used as the cathode. To suppress aggregation of silver, a silver alloy may be used. The ratio of the alloy is not limited as long as aggregation of silver can be suppressed. For example, the ratio between silver and another metal may be 1:1, 3:1, or the like.

The cathode may be a top emission element using an oxide conductive layer made of ITO or the like, or may be a bottom emission element using a reflective electrode made of aluminum (Al) or the like, and is not particularly limited. The method of forming the cathode is not particularly limited, but if direct current sputtering or alternating current sputtering is used, the good coverage is achieved for the film to be formed, and the resistance of the cathode can be lowered.

### Pixel Isolation Layer

A pixel isolation layer may be formed by a so-called silicon oxide, such as silicon nitride (SiN), silicon oxynitride (SiON), or silicon oxide (SiO), formed using a chemical vapor deposition (CVD) method. To increase the resistance in the in-plane direction of the organic compound layer, the organic compound layer, especially the hole transport layer may be thinly deposited on the side wall of the pixel isolation layer. More specifically, the organic compound layer can be deposited so as to have a thin film thickness on the side wall by increasing the taper angle of the side wall of the pixel isolation layer or the film thickness of the pixel isolation layer to increase vignetting during vapor deposition.

On the other hand, the taper angle of the side wall of the pixel isolation layer or the film thickness of the pixel isolation layer can be adjusted to the extent that no space is formed in the protection layer formed on the pixel isolation layer. Since no space is formed in the protection layer, it is possible to reduce generation of defects in the protection layer. Since generation of defects in the protection layer is reduced, a decrease in reliability caused by generation of a dark spot or occurrence of a conductive failure of the second electrode can be reduced.

Even if the taper angle of the side wall of the pixel isolation layer is not acute, it is possible to effectively suppress leakage of charges to an adjacent pixel. As a result of this consideration, it has been found that the taper angle of 60° (inclusive) to 90° (inclusive) can sufficiently reduce the occurrence of defects. The film thickness of the pixel isolation layer may be 10 nm (inclusive) to 150 nm (inclusive). A similar effect can be obtained in a configuration including only pixel electrodes without the pixel isolation layer. However, in this case, the film thickness of the pixel electrode is set to be equal to or smaller than half the film thickness of the organic layer or the end portion of the pixel electrode is formed to have a forward tapered shape of less than 60°. With this, short circuit of the organic light emitting element can be reduced.

In a case where the first electrode is the cathode and the second electrode is the anode, a high color gamut and low-voltage driving can be achieved by forming the electron transport material and charge transport layer and forming the light emitting layer on the charge transport layer.

### Organic Compound Layer

The organic compound layer may be formed by a single layer or multiple layers. If the organic compound layer includes layers, the layers can be called a hole injection layer, a hole transport layer, an electron blocking layer, a light emitting layer, a hole blocking layer, an electron transport layer, and an electron injection layer in accordance with the functions of the layers. The organic compound layer is mainly formed from an organic compound but may contain inorganic atoms and an inorganic compound. For example, the organic compound layer may contain copper, lithium, magnesium, aluminum, iridium, platinum, molybdenum, zinc, or the like. The organic compound layer may be arranged between the first and second electrodes, and may be arranged in contact with the first and second electrodes.

If light emitting layers are provided, a charge generation portion may be arranged between the first light emitting layer and the second light emitting layer which are stacked. The charge generation portion may contain an organic compound with a LUMO of −5.0 eV or less. The same applies to a case where a charge generating portion is provided between the second light emitting layer and the third light emitting layer which are stacked.

### Protection Layer

A protection layer may be provided on the cathode. For example, by adhering glass provided with a moisture absorbing agent on the cathode, permeation of water or the like into the organic compound layer can be suppressed and occurrence of display defects can be suppressed. As another embodiment, a passivation layer made of silicon nitride or the like may be provided on the cathode to suppress permeation of water or the like into the organic compound layer. For example, the protection layer can be formed by forming the cathode, transferring it to another chamber without breaking the vacuum, and forming silicon nitride having a thickness of 2 μm by the CVD method. The protection layer may be provided using an atomic layer deposition (ALD) method after deposition of the protection layer using the CVD method. The material of the protection layer by the ALD method is not limited but can be silicon nitride, silicon oxide, aluminum oxide, or the like. Silicon nitride may further be formed by the CVD method on the protection layer formed by the ALD method. The protection layer formed by the ALD method may have a film thickness smaller than that of the protection layer formed by the CVD method. More specifically, the film thickness of the protection layer formed by the ALD method may be 50% or less, or 10% or less of that of the protection layer formed by the CVD method.

### Color Filter

A color filter may be provided on the protection layer. For example, a color filter considering the size of the organic light emitting element may be provided on another substrate, and the substrate with the color filter formed thereon may be bonded to the substrate with the organic light emitting element provided thereon. Alternatively, for example, a color filter may be patterned on the above-described protection layer using a photolithography technique. The color filter may be formed from a polymeric material.

### Planarizing Layer

A planarizing layer may be arranged between the color filter and the protection layer. The planarizing layer is provided to reduce unevenness of the layer below the planarizing layer. The planarizing layer may be called a material resin layer without limiting the purpose of the layer. The planarizing layer may be formed from an organic compound, and may be made of a low-molecular material or a polymeric material. To reduce unevenness, a polymeric organic compound may be used for the planarizing layer.

The planarizing layers may be provided above and below the color filter. In that case, the same or different constituent materials may be used for these planarizing layers. Examples of the material of the planarizing layer include polyvinyl carbazole resin, polycarbonate resin, polyester resin, ABS resin, acrylic resin, polyimide resin, phenol resin, epoxy resin, silicone resin, and urea resin.

### Microlens

The organic light emitting device may include an optical member such as a microlens on the light emission side. The microlens can be made of acrylic resin, epoxy resin, or the like. The microlens can aim to increase the amount of light extracted from the organic light emitting device and control the direction of light to be extracted. The microlens can have a hemispherical shape. If the microlens has a hemispherical shape, among tangents contacting the hemisphere, there is a tangent parallel to the insulating layer, and the contact between the tangent and the hemisphere is the vertex of the microlens. The vertex of the microlens can be decided in the same manner even in an arbitrary sectional view. That is, among tangents contacting the semicircle of the microlens in a sectional view, there is a tangent parallel to the insulating layer, and the contact between the tangent and the semicircle is the vertex of the microlens.

The middle point of the microlens can also be defined. In the section of the microlens, a line segment from a point at which an arc shape ends to a point at which another arc shape ends is assumed, and the middle point of the line segment can be called the middle point of the microlens. A section for determining the vertex and the middle point may be a section perpendicular to the insulating layer.

The microlens includes a first surface including a convex portion and a second surface opposite to the first surface. The second surface can be arranged on the functional layer (light emitting layer) side of the first surface. For this configuration, the microlens is to be formed on the light emitting device. If the functional layer is an organic layer, a process which produces high temperature in the manufacturing step of the microlens may be avoided. In addition, if it is configured to arrange the second surface on the functional layer side of the first surface, all the glass transition temperatures of an organic compound forming the organic layer may be 100° C. or more. For example, 130° C. or more is suitable.

### Counter Substrate

A counter substrate may be arranged on the planarizing layer. The counter substrate is called a counter substrate because it is provided at a position corresponding to the above-described substrate. The constituent material of the counter substrate can be the same as that of the above-described substrate. If the above-described substrate is the first substrate, the counter substrate can be the second substrate.

### Organic Layer

The organic compound layer (hole injection layer, hole transport layer, electron blocking layer, light emitting layer, hole blocking layer, electron transport layer, electron injection layer, and the like) forming the organic light emitting element of the present disclosure may be formed by the method described herein.

The organic compound layer forming the organic light emitting element of the present disclosure can be formed by a dry process using a vacuum deposition method, an ionization deposition method, a sputtering method, a plasma method, or the like. Instead of the dry process, a wet process that forms a layer by dissolving a solute in an appropriate solvent and using a well-known coating method (for example, a spin coating method, a dipping method, a casting method, an LB method, an inkjet method, or the like) can be used.

When the layer is formed by a vacuum deposition method, a solution coating method, or the like, crystallization or the like hardly occurs and excellent temporal stability is obtained. When the layer is formed using a coating method, it is possible to form the film in combination with a suitable binder resin.

Examples of the binder resin include polyvinyl carbazole resin, polycarbonate resin, polyester resin, ABS resin, acrylic resin, polyimide resin, phenol resin, epoxy resin, silicone resin, and urea resin. However, the binder resin is not limited to them.

One of these binder resins may be used singly as a homopolymer or a copolymer, or two or more of them may be used in combination. Additives such as a well-known plasticizer, antioxidant, and an ultraviolet absorber may also be used.

### Pixel Circuit

The light emitting device can include a pixel circuit connected to the light emitting element. The pixel circuit may be an active matrix circuit that individually controls light emission of the first and second light emitting elements. The active matrix circuit may be a voltage or current programing circuit. A driving circuit includes a pixel circuit for each pixel. The pixel circuit can include a light emitting element, a transistor for controlling light emission luminance of the light emitting element, a transistor for controlling a light emission timing, a capacitor for holding the gate voltage of the transistor for controlling the light emission luminance, and a transistor for connection to GND without intervention of the light emitting element.

The light emitting device includes a display region and a peripheral region arranged around the display region. The light emitting device includes the pixel circuit in the display region and a display control circuit in the peripheral region. The mobility of the transistor forming the pixel circuit may be smaller than that of a transistor forming the display control circuit.

The slope of the current-voltage characteristic of the transistor forming the pixel circuit may be smaller than that of the current-voltage characteristic of the transistor forming the display control circuit. The slope of the current-voltage characteristic can be measured by a so-called Vg-Ig characteristic.

The transistor forming the pixel circuit is a transistor connected to the light emitting element such as the first light emitting element.

### Pixel

The organic light emitting device includes pixels. Each pixel includes sub-pixels that emit light components of different colors. The sub-pixels may include, for example, R, G, and B emission colors, respectively.

In each pixel, a region called a pixel opening emits light. The pixel opening can have a size of 5 μm (inclusive) to 15 μm (inclusive). More specifically, the pixel opening can have a size of 11 μm, 9.5 μm, 7.4 μm, 6.4 μm, or the like.

A distance between the sub-pixels can be 10 μm or less, and can be, more specifically, 8 μm, 7.4 μm, or 6.4 μm.

The pixels can have a known arrangement form in a plan view. For example, the pixels may have a stripe arrangement, a delta arrangement, a pentile arrangement, or a Bayer arrangement. The shape of each sub-pixel in a plan view may be any known shape. For example, a quadrangle such as a rectangle or a rhombus, a hexagon, or the like may be possible. A shape which is not a correct shape but is close to a rectangle is included in a rectangle, as a matter of course. The shape of the sub-pixel and the pixel arrangement can be used in combination.

### Application of Organic Light Emitting Element

The organic light emitting element according to an embodiment of the present disclosure can be used as a constituent member of a display apparatus or an illumination apparatus. In addition, the organic light emitting element is applicable to the exposure light source of an electrophotographic image forming apparatus, the backlight of a liquid crystal display apparatus, a light emitting device including a color filter in a white light source, and the like.

The display apparatus may be an image information processing apparatus that includes an image input unit for inputting image information from an area CCD, a linear CCD, a memory card, or the like, and an information processing unit for processing the input information, and displays the input image on a display unit.

In addition, a display unit included in an image capturing apparatus or an inkjet printer can have a touch panel function. The driving type of the touch panel function may be an infrared type, a capacitance type, a resistive film type, or an electromagnetic induction type, and is not particularly limited. The display apparatus may be used for the display unit of a multifunction printer.

FIG. 12A shows an example of the pixel arranged in the light emitting region 105 of the light emitting device 100. The pixel includes sub-pixels 810. The sub-pixels are divided into sub-pixels 810R, 810G, and 810B as individual light emitting components for emission of different color light, emission of which may be discriminated by the wavelengths of components of the light emitting layers. Alternatively, light emitted from each sub-pixel may be selectively transmitted or undergo color conversion by a color filter or the like. Each sub-pixel includes a reflective electrode 802 as the first electrode on an interlayer insulating layer 801, an insulating layer 803 covering the end of the reflective electrode 802, an organic compound layer 804 covering the first electrode and the insulating layer, a transparent electrode 805 as the second electrode, a protection layer 806, and a color filter.

The interlayer insulating layer 801 can include a transistor and a capacitive element arranged in the interlayer insulating layer 801 or a layer below the interlayer insulating layer 801. The transistor and the first electrode can be electrically connected via a contact hole or the like.

The insulating layer 803 may also be referred to as a bank or a pixel isolation film. The insulating layer 803 covers the end of the first electrode, and is arranged to surround the first electrode. A portion of the first electrode where no insulating layer 803 is arranged is in contact with the organic compound layer 804 to form a light emitting region.

The organic compound layer 804 includes a hole injection layer 841, a hole transport layer 842, a first light emitting layer 843, a second light emitting layer 844, and an electron transport layer 845.

The second electrode may be a transparent electrode, a reflective electrode, or a semi-transmissive electrode.

The protection layer 806 suppresses permeation of water into the organic compound layer. The protection layer is shown as a single layer but may include a plurality of layers. Each layer can be an inorganic compound layer or an organic compound layer.

The color filter is divided into color filters 807R, 807G, and 807B by colors. The color filters can be formed on a planarizing film. A resin protection layer may be arranged on the color filters. The color filters can be formed on the protection layer 806. Alternatively, the color filters can be provided on the counter substrate such as a glass substrate, and then the substrate may be bonded.

The display apparatus 800 (corresponding to the light emitting device 100 described above) shown in FIG. 12B is provided with an organic light emitting element 826 and a TFT 818 as an example of a transistor. A substrate 811 of glass, silicon, or the like is provided and an insulating layer 812 is provided on the substrate 811. The active element such as the TFT 818 is arranged on the insulating layer, and a gate electrode 813, a gate insulating film 814, and a semiconductor layer 815 of the active element are arranged. The TFT 818 further includes the semiconductor layer 815, a drain electrode 816, and a source electrode 817. An insulating film 819 is provided on the TFT 818. The source electrode 817 and an anode 821 forming the organic light emitting element 826 are connected via a contact hole 820 formed in the insulating film.

A method of electrically connecting the electrodes (anode and cathode) included in the organic light emitting element 826 and the electrodes (source electrode and drain electrode) included in the TFT is not limited to that shown in FIG. 12B. That is, one of the anode and cathode and one of the source electrode and drain electrode of the TFT are electrically connected.

In the display apparatus 800 shown in FIG. 12B, an organic compound layer is illustrated as one layer. However, an organic compound layer 822 may include a plurality of layers. A first protection layer 824 and a second protection layer 825 are provided on a cathode 823 to suppress deterioration of the organic light emitting element.

A transistor is used as a switching element in the display apparatus 800 shown in FIG. 12B, but another switching element may be used instead.

The transistor used in the display apparatus 800 shown in FIG. 12B is not limited to a transistor using a single-crystal silicon wafer, and may be a thin-film transistor including an active layer on an insulating surface of a substrate. Examples of the active layer include single-crystal silicon, amorphous silicon, non-single-crystal silicon such as microcrystalline silicon, and a non-single-crystal oxide semiconductor such as indium zinc oxide and indium gallium zinc oxide.

The transistor included in the display apparatus 800 shown in FIG. 12B may be formed in the substrate such as a silicon substrate. Forming the transistor in the substrate means forming the transistor by processing the substrate such as a silicon substrate. That is, when the transistor is included in the substrate, it can be considered that the substrate and the transistor are formed integrally.

The light emission luminance of the organic light emitting element can be controlled by the TFT which is an example of a switching element, and organic light emitting elements can be provided in a plane to display an image with the light emission luminances of the respective elements. The switching element is not limited to the TFT, and may be a transistor formed from low-temperature polysilicon or an active matrix driver formed on the substrate such as a silicon substrate. Herein, “on the substrate” may mean “in the substrate”. Whether to provide a transistor in the substrate or use a TFT is selected based on the size of the display unit. For example, if the size is about 0.5 inch, the organic light emitting element may be provided on the silicon substrate.

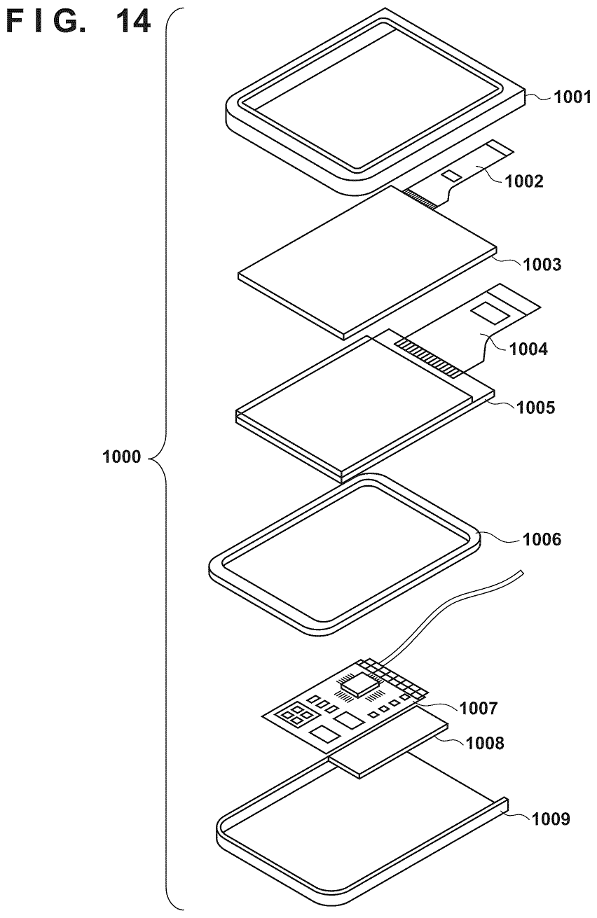

FIGS. 13A to 13C are schematic views showing an example of an image forming apparatus using the light emitting device 100 according to an embodiment. An image forming apparatus 926 shown in FIG. 13A includes a photosensitive member 927, an exposure light source 928, a developing unit 931, a charging unit 930, a transfer device 932, a conveyance unit 933 (arranged as a conveyance roller in FIG. 13A), and a fixing device 935. The exposure light source 928 corresponds to the head substrate 1800 shown in FIG. 11A. Hence, the light emitting device 100 (LED chip 1803) described above can be used as the exposure light source 928 of the image forming apparatus 926.

Light 929 is emitted from the exposure light source 928, and an electrostatic latent image is formed on the surface of the photosensitive member 927. The light emitting device 100 can be applied to the exposure light source 928. The developing unit 931 can function as a developing device that includes toner or the like as a developing agent and applies the developing agent to the exposed photosensitive member 927. The charging unit 930 charges the photosensitive member 927. The transfer device 932 transfers the developed image to a print medium 934. The conveyance unit 933 conveys the print medium 934. The print medium 934 can be, for example, paper, a film, or the like. The fixing device 935 fixes the image formed on the print medium.

Each of FIGS. 13B and 13C is a schematic view showing a form in which light emitting elements 936 are arranged in the exposure light source 928 along the longitudinal direction of a long substrate. The light emitting device 100 can be applied to each of the light emitting elements 936. That is, the plurality of pixels are arranged along the longitudinal direction of the substrate. A direction 937 is a direction parallel to the axis of the photosensitive member 927. This column direction matches the direction of the axis upon rotating the photosensitive member 927. This direction 937 can also be referred to as the long-axis direction of the photosensitive member 927.

FIG. 13B shows a form in which the light emitting elements 936 are arranged along the long-axis direction of the photosensitive member 927. FIG. 13C shows a form, which is a modification of the arrangement of the light emitting elements 936 shown in FIG. 13B, in which the light emitting elements 936 are arranged in the column direction alternately between the first column and the second column. The light emitting elements 936 are arranged at different positions in the row direction between the first column and the second column. In the first column, light emitting elements 936 are arranged apart from each other. In the second column, the light emitting element 936 is arranged at the position corresponding to the space between the light emitting elements 936 in the first column. In the row direction, light emitting elements 936 are arranged apart from each other. The arrangement of the light emitting elements 936 shown in FIG. 13C can be referred to as, for example, an arrangement in a grid pattern, an arrangement in a staggered pattern, or an arrangement in a checkered pattern.

FIG. 14 is a schematic view showing an example of the display apparatus using the light emitting device 100 according to an embodiment. A display apparatus 1000 can include a touch panel 1003, a display panel 1005, a frame 1006, a circuit board 1007, and a battery 1008 between an upper cover 1001 and a lower cover 1009. Flexible printed circuits (FPCs) 1002 and 1004 are respectively connected to the touch panel 1003 and the display panel 1005. Active elements such as transistors are arranged on the circuit board 1007. The battery 1008 may be omitted if the display apparatus 1000 is not portable equipment. Even when the display apparatus 1000 is portable equipment, the battery 1008 need not be provided at this position. The light emitting device 100 can be applied to the display panel 1005. The light emitting element arranged in the light emitting device 100 functioning as the display panel 1005 are connected to the active element such as the transistor arranged on the circuit board 1007 and operate.

The display apparatus 1000 shown in FIG. 14 can be used for a display unit of a photoelectric conversion apparatus (also referred to as an image capturing apparatus) including an optical unit having a plurality of lenses, and an image sensor for receiving light having passed through the optical unit and photoelectrically converting the light into an electric signal. The photoelectric conversion apparatus can include a display unit for displaying information acquired by the image sensor. In addition, the display unit can be either a display unit exposed outside the photoelectric conversion apparatus, or a display unit arranged in the finder. The photoelectric conversion apparatus can be a digital camera or a digital video camera.

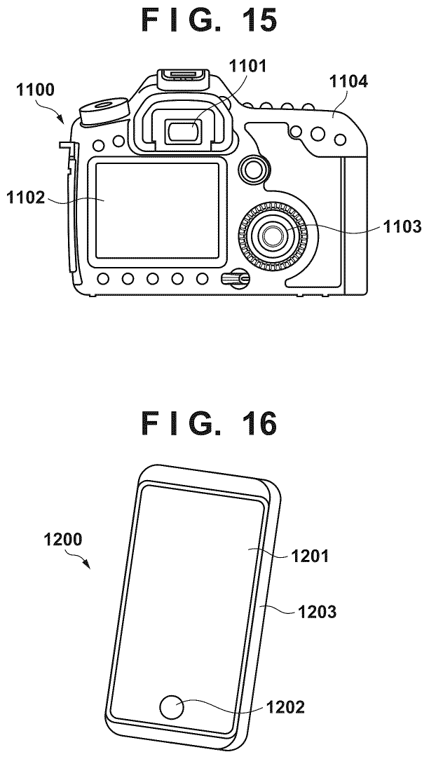

FIG. 15 is a schematic view showing an example of the photoelectric conversion apparatus using the light emitting device 100. A photoelectric conversion apparatus 1100 can include a viewfinder 1101, a rear display 1102, an operation unit 1103, and a housing 1104. The photoelectric conversion apparatus 1100 may also be referred to as an image capturing apparatus. The light emitting device 100 can be applied to the viewfinder 1101 or the rear display 1102 as a display unit. In this case, the light emitting device 100 can display not only an image to be captured but also environment information, image capturing instructions, and the like. Examples of the environment information are the intensity and direction of external light, moving velocity of an object, and a possibility that an object is covered with an obstacle.

The timing suitable for image capturing is a very short time in many cases. Thus, it is better to display the information as soon as possible. Therefore, the light emitting device 100 in which the pixel including the light emitting element using the organic light emitting material such as an organic EL element is arranged may be used for the viewfinder 1101 or the rear display 1102, with the organic light emitting material having a high response speed. The light emitting device 100 using the organic light emitting material can be used for the apparatuses that require a high display speed more suitably than for the liquid crystal display apparatus.

The photoelectric conversion apparatus 1100 includes an optical unit. This optical unit has a plurality of lenses, and forms an image on a photoelectric conversion element that receives light having passed through the optical unit and is accommodated in the housing 1104. The focal points of the plurality of lenses can be adjusted by adjusting the relative positions. This operation can also automatically be performed.

The light emitting device 100 may be applied to a display unit of electronic equipment. At this time, the display unit can have both a display function and an operation function. Examples of the portable terminal are a portable phone such as a smartphone, a tablet, and a head mounted display.

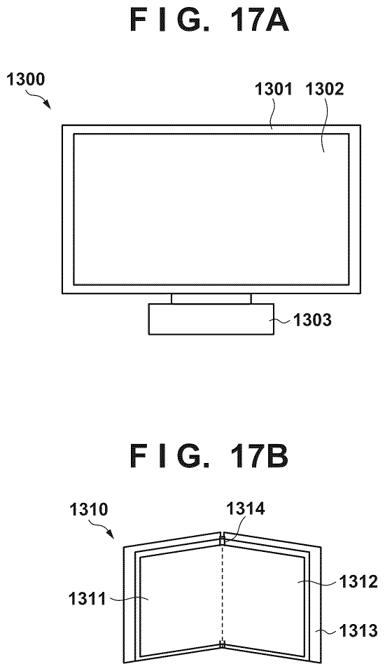

FIG. 16 is a schematic view showing an example of electronic equipment using the light emitting device 100 according to an embodiment. Electronic equipment 1200 includes a display unit 1201, an operation unit 1202, and a housing 1203. The housing 1203 can accommodate a circuit, a printed board having this circuit, a battery, and a communication unit. The operation unit 1202 can be a button or a touch-panel-type reaction unit. The operation unit 1202 can also be a biometric authentication unit that performs unlocking or the like by authenticating the fingerprint. The portable equipment including the communication unit can also be regarded as communication equipment. The light emitting device 100 can be applied to the display unit 1201.

FIGS. 17A and 17B are schematic views showing examples of the display apparatus using the light emitting device 100 according to an embodiment. FIG. 17A shows a display apparatus such as a television monitor or a PC monitor. A display apparatus 1300 includes a frame 1301 and a display unit 1302. The light emitting device 100 can be applied to the display unit 1302. The display apparatus 1300 can include a base 1303 that supports the frame 1301 and the display unit 1302. The base 1303 is not limited to the form shown in FIG. 17A. For example, the lower side of the frame 1301 may also function as the base 1303. In addition, the frame 1301 and the display unit 1302 can be bent. The radius of curvature in this case can be 5,000 mm (inclusive) to 6,000 mm (inclusive).

FIG. 17B is a schematic view showing another example of the display apparatus using the light emitting device 100. A display apparatus 1310 shown in FIG. 17B can be folded, and is a so-called foldable display apparatus. The display apparatus 1310 includes a first display unit 1311, a second display unit 1312, a housing 1313, and a bending point 1314. The light emitting device 100 can be applied to each of the first display unit 1311 and the second display unit 1312. The first display unit 1311 and the second display unit 1312 can also be one seamless display apparatus. The first display unit 1311 and the second display unit 1312 can be divided by the bending point. The first display unit 1311 and the second display unit 1312 can display different images, and can also display one image together.

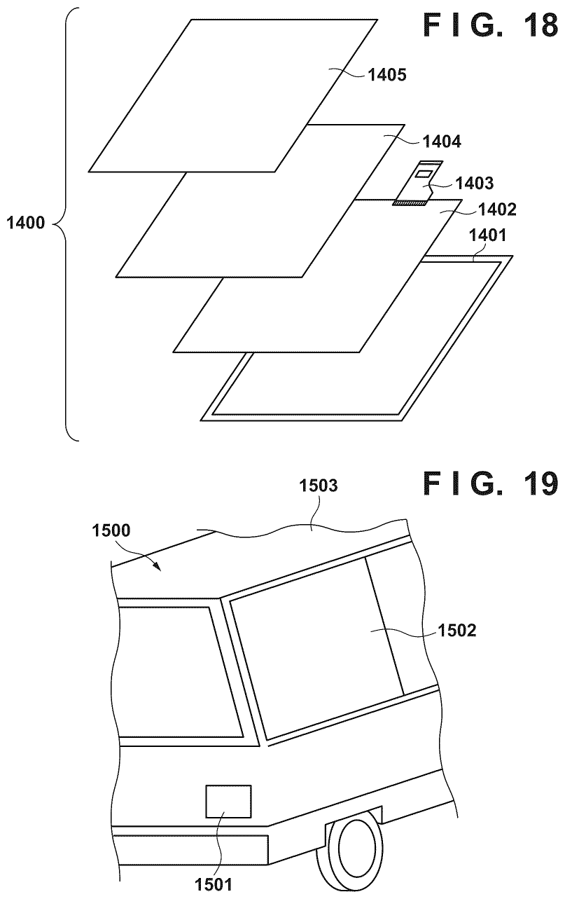

FIG. 18 is a schematic view showing an example of the illumination apparatus using the light emitting device 100 according to an embodiment. An illumination apparatus 1400 can include a housing 1401, a light source 1402, a circuit board 1403, an optical film 1404, and a light diffusing unit 1405. The light emitting device 100 can be applied to the light source 1402. The optical film 1404 can be a filter that improves the color rendering of the light source. When performing lighting-up or the like, the light diffusing unit 1405 can throw the light of the light source over a broad range by effectively diffusing the light. The illumination apparatus can also include a cover on the outermost portion, as needed. The illumination apparatus 1400 can include both or one of the optical film 1404 and the light diffusing unit 1405.

The illumination apparatus 1400 is, for example, an apparatus for illuminating the interior of the room. The illumination apparatus 1400 can emit white light, natural white light, or light of any color from blue to red. The illumination apparatus 1400 can also include a light control circuit for controlling these light components. The illumination apparatus 1400 can also include a power supply circuit connected to the light emitting device 100 functioning as the light source 1402. The power supply circuit is a circuit for converting an alternating current (AC) voltage to a direct current (DC) voltage. White has a color temperature of 4,200 K, and natural white has a color temperature of 5,000 K. The illumination apparatus 1400 may also include a color filter. In addition, the illumination apparatus 1400 can include a heat radiation unit. The heat radiation unit radiates the internal heat of the apparatus to the outside of the apparatus, and examples are a metal having a high specific heat and liquid silicon.

FIG. 19 is a schematic view of an automobile having a taillight as an example of a vehicle lighting appliance using the light emitting device 100 according to an embodiment. An automobile 1500 has a taillight 1501, and can have a form in which the taillight 1501 is turned on when performing a braking operation or the like. The light emitting device 100 can be used as a headlight serving as a vehicle lighting appliance. The automobile is an example of a moving body, and the moving body may be a ship, a drone, an aircraft, a railroad car, an industrial robot, or the like. The moving body may include a main body and a lighting appliance provided in the main body. The lighting appliance may be used to make a notification of the current position of the main body.

The light emitting device 100 can be applied to the taillight 1501. The taillight 1501 can include a protection member for protecting the light emitting device 100 functioning as the taillight 1501. The material of the protection member is not limited as long as the material is a transparent material with a strength that is high to some extent, and an example is polycarbonate. The protection member may be made of a material obtained by mixing a furandicarboxylic acid derivative, an acrylonitrile derivative, or the like in polycarbonate.

The automobile 1500 can include a vehicle body 1503, and a window 1502 attached to the vehicle body 1503. This window can be utilized for checking the front and back of the automobile, and can also be a transparent display such as a head-up display. For this transparent display, the light emitting device 100 may be used. In this case, the constituent materials of the electrodes and the like of the light emitting device 100 are formed by transparent members.

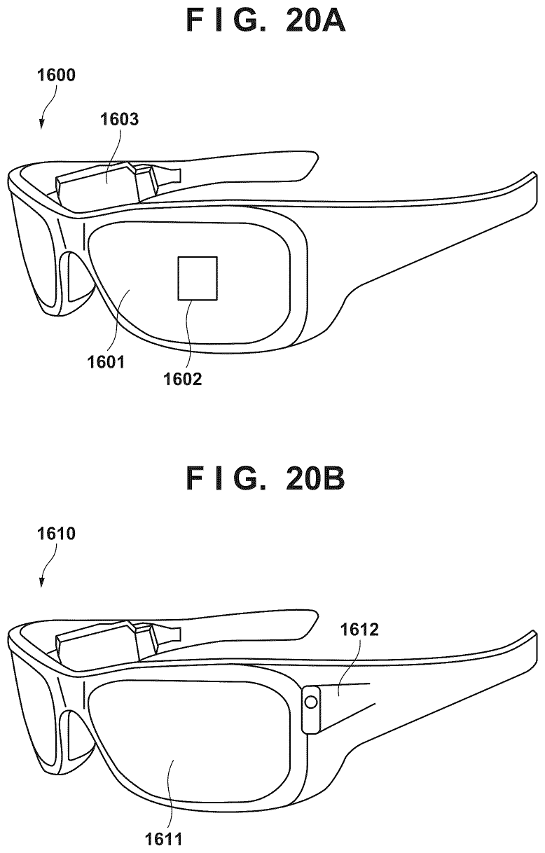

Further application examples of the light emitting device 100 will be described with reference to FIGS. 20A and 20B. The light emitting device 100 can be applied to a system that can be worn as a wearable device such as smart glasses, a Head Mounted Display (HMD), or a smart contact lens. An image capturing display apparatus used for such application examples includes an image capturing apparatus capable of photoelectrically converting visible light and a light emitting apparatus capable of emitting visible light.

Glasses 1600 (smart glasses) according to one application example will be described with reference to FIG. 20A. An image capturing apparatus 1602 such as a complementary metal oxide semiconductor (CMOS) sensor or a single photon avalanche diode (SPAD) is provided on the surface side of a lens 1601 of the glasses 1600. In addition, the light emitting device 100 is provided on the back surface side of the lens 1601.

The glasses 1600 further include a control apparatus 1603. The control apparatus 1603 functions as a power supply that supplies electric power to the image capturing apparatus 1602 and the light emitting device 100. In addition, the control apparatus 1603 controls the operations of the image capturing apparatus 1602 and the light emitting device 100. An optical system configured to condense light to the image capturing apparatus 1602 is formed on the lens 1601.

Glasses 1610 (smart glasses) according to an embodiment will be described with reference to FIG. 20B. The glasses 1610 include a control apparatus 1612, and an image capturing apparatus corresponding to the image capturing apparatus 1602 and the light emitting device 100 are mounted on the control apparatus 1612. The image capturing apparatus in the control apparatus 1612 and an optical system configured to project light emitted from the light emitting device 100 are formed in a lens 1611, and an image is projected to the lens 1611. The control apparatus 1612 functions as a power supply that supplies electric power to the image capturing apparatus and the light emitting device 100, and controls the operations of the image capturing apparatus and the light emitting device 100. The control apparatus 1612 may include a line-of-sight detection unit that detects the line of sight of a wearer. The detection of a line of sight may be performed using infrared rays. An infrared ray emitting unit emits infrared rays to an eyeball of the user who is gazing at a displayed image. An image capturing unit including a light receiving element detects reflected light of the emitted infrared rays from the eyeball, thereby obtaining a captured image of the eyeball. A reduction unit for reducing light from the infrared ray emitting unit to the display unit in a planar view is provided, thereby reducing deterioration of image quality.

The line of sight of the user to the displayed image is detected from the captured image of the eyeball obtained by capturing the infrared rays. An arbitrary known method can be applied to the line-of-sight detection using the captured image of the eyeball. As an example, a line-of-sight detection method based on a Purkinje image obtained by reflection of irradiation light by a cornea can be used.

More specifically, line-of-sight detection processing based on pupil center corneal reflection is performed. Using pupil center corneal reflection, a line-of-sight vector representing the direction (rotation angle) of the eyeball is calculated based on the image of the pupil and the Purkinje image included in the captured image of the eyeball, thereby detecting the line-of-sight of the user.

The light emitting device 100 according to the present disclosure can include an image capturing apparatus including a light receiving element, and control a displayed image based on the line-of-sight information of the user from the image capturing apparatus.

More specifically, the light emitting device 100 decides a first visual field region at which the user is gazing and a second visual field region other than the first visual field region based on the line-of-sight information. The first visual field region and the second visual field region may be decided by the control apparatus of the light emitting device 100, or those decided by an external control apparatus may be received. In the display region of the light emitting device 100, the display resolution of the first visual field region may be controlled to be higher than the display resolution of the second visual field region. That is, the resolution of the second visual field region may be lower than that of the first visual field region.

In addition, the display region includes a first display region and a second display region different from the first display region, and a region of higher priority is decided from the first display region and the second display region based on line-of-sight information. The first display region and the second display region may be decided by the control apparatus of the light emitting device 100, or those decided by an external control apparatus may be received. The resolution of the region of higher priority may be controlled to be higher than the resolution of the region other than the region of higher priority. That is, the resolution of the region of relatively low priority may be low.

Artificial intelligence (AI) may be used to decide the first visual field region or the region of higher priority. The AI may be a model configured to estimate the angle of the line of sight and the distance to a target ahead the line of sight from the image of the eyeball using the image of the eyeball and the direction of actual viewing of the eyeball in the image as supervised data. The AI program may be held by the light emitting device 100, the image capturing apparatus, or an external apparatus. If the external apparatus holds the AI program, it is transmitted to the light emitting device 100 via communication.

When performing display control based on line-of-sight detection, the smart glasses may further include an image capturing apparatus configured to capture the outside can be applied. The smart glasses can display captured outside information in real time.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of and priority to Japanese Patent Application No. 2024-093861, which was filed on Jun. 10, 2024, the entirety of which is incorporated herein by reference.

What is claimed is:

1. A light emitting device comprising:
a substrate with a light emitting region in which a plurality of light emitting elements are arranged, the light emitting region extending in a longitudinal direction;
a processing circuit configured to process a data signal for controlling light emission luminance of each light emitting element of the plurality of the light emitting elements in accordance with a clock signal; and
a plurality of terminals aligned in the longitudinal direction, wherein:
the plurality of terminals includes a first terminal, a second terminal, and a third terminal, with the second terminal and the third terminal arranged adjacent to each other,
the processing circuit and the plurality of terminals are arranged in the longitudinal direction, and
the second terminal is supplied with one of the clock signal and the data signal, and the third terminal is supplied with one of another clock signal and data signal.

2. The light emitting device according to claim 1, wherein the second terminal and the third terminal are arranged between the processing circuit and the first terminal.

3. The light emitting device according to claim 2, wherein:
the second terminal is supplied with the data signal, and the third terminal is supplied with the clock signal, and
the third terminal is arranged between the processing circuit and the second terminal.

4. The light emitting device according to claim 1, wherein a pulse width of the clock signal is shorter than a transition cycle of data of the data signal which corresponds to each light emitting element.

5. The light emitting device according to claim 3, wherein:
the plurality of terminals further include a fourth terminal arranged between the first terminal and the second terminal,
a pulse width of the clock signal is shorter than a transition cycle of data of the data signal which corresponds to each light emitting element, and
the fourth terminal is supplied with a signal that transitions at a cycle not less than a transition cycle of data of the data signal which corresponds to each light emitting element.

6. The light emitting device according to claim 3, wherein:
the plurality of terminals further include a fourth terminal arranged between the first terminal and the second terminal,
a pulse width of the clock signal is shorter than a transition cycle of data of the data signal which corresponds to each light emitting element,
the first terminal is supplied with a signal that transitions at a cycle longer than a transition cycle of data of the data signal which corresponds to each light emitting element, and
the fourth terminal is a terminal for power supply.

7. The light emitting device according to claim 1, wherein the first terminal is a power supply terminal.

8. The light emitting device according to claim 1, wherein the first terminal is supplied with a signal that transitions at a cycle longer than a transition cycle of data of the data signal which corresponds to each light emitting element.

9. The light emitting device according to claim 1, wherein:
the substrate has a rectangular shape, and
the longitudinal direction extends along long sides of the rectangular shaped substrate.

10. The light emitting device according to claim 1, wherein the light emitting region is arranged in a second direction, which intersects the longitudinal direction, with respect to the processing circuit and the plurality of terminals.

11. The light emitting device according to claim 1, further comprising a scanning circuit configured to scan the plurality of light emitting elements in accordance with a signal supplied from the processing circuit.

12. The light emitting device according to claim 11, wherein the scanning circuit is arranged between the processing circuit and the light emitting region.

13. The light emitting device according to claim 1, wherein:
the processing circuit includes an obtaining circuit to which the clock signal and the data signal are input, and
in a planar view with respect to the substrate, the obtaining circuit is arranged at a position closer to the plurality of terminals than a center of the processing circuit.

14. The light emitting device according to claim 1, wherein:
a moisture-proof ring surrounding the light emitting region, the processing circuit, and the plurality of terminals are arranged along an outer edge of the substrate, and
in a planar view with respect to the substrate, the moisture-proof ring includes a concave portion between the plurality of terminals and the processing circuit.

15. A light emitting module comprising a plurality of light emitting devices,
wherein each light emitting device of the plurality of light emitting devices is arranged as the light emitting device according to claim 1.

16. An image forming apparatus comprising:
a photosensitive member;
an exposure light source configured to expose the photosensitive member;
a developing device configured to apply a developing agent to the exposed photosensitive member; and
a transfer device configured to transfer an image developed by the developing device to a print medium,
wherein the exposure light source includes the light emitting device according to claim 1.
